(19) United States
(12) Patent Application Publication
(10) Pub. No.: US 2016/0248526 A1
(43) Pub. Date: Aug. 25, 2016

(54) SYSTEMS AND METHODS OF FINGERPRINTING AND IDENTIFYING REALTIME BROADCASTING SIGNALS

(71) Applicants: Yangbin Wang, Palo Alto, CA (US); Lei Yu, Hangzhou (CN)

(72) Inventors: Yangbin Wang, Palo Alto, CA (US); Lei Yu, Hangzhou (CN)

(21) Appl. No.: 15/146,119

(22) Filed: May 4, 2016

Related U.S. Application Data
(63) Continuation-in-part of application No. 14/165,547, filed on Jan. 27, 2014, now Pat. No. 9,367,744.

(51) Int. Cl. H04H 60/59; H04N 21/44; G11B 27/22; H04N 21/41; H04N 21/8358; H04N 21/234; H04N 21/2187

(52) U.S. Cl. CPC H04H 60/59; H04N 21/23418; H04N 21/44008; H04N 21/2187; H04N 21/4122; H04N 21/8358; G11B 27/22; G11B 2220/2562

(57) ABSTRACT

Systems and methods are provided for identifying a video object using digital fingerprints. The digital fingerprints are generated from information extracted from the video object including encoded video. The digital fingerprints can be calculated in a manner that permits identification of both the video object and operational characteristics of the video object based on matching calculated digital fingerprints with known fingerprints of known video objects. Systems and methods are described that allow a DVD to be uniquely identified and identify whether the DVD is original, copied or pirated. Systems and methods are described for computing digital fingerprints from strings of bits in which certain additional data is optionally embedded. Systems and methods are described that permit media players to access known signatures of known video objects maintained on one or more databases and to identify video objects presented for playing on the media player. In the parent application, the video object is extended to media content including video and audio, and DVD is extended to media file, network stream and other content mediums. In the present application, the media content is extended to real-time broadcasting signals.

### CROSS-REFERENCE TO RELATED APPLICATIONS

The present application is a Continuation-in-Part of U.S. application Ser. No. 14/165,547, filed Jan. 27, 2014, entitled “SYSTEMS AND METHODS OF FINGERPRINTING AND IDENTIFYING MEDIA CONTENTS” and which is incorporated herein by reference and for all purposes.

### BACKGROUND OF THE INVENTION

1. Field of the Invention

The present invention relates generally to techniques for fingerprinting and identifying media contents including Digital Versatile Discs (DVD), and more particularly to methods and apparatus for generating multiple content-based IDs or fingerprints and using these fingerprints to uniquely identify a media content including DVD.

2. Description of Related Art

The Digital Versatile Disc (DVD) has become very popular in the past decade thanks to the ubiquitous low-cost DVD players as well as the availability of video content on DVDs. According to DVD Entertainment Group, by the end of 2005, more than 80% of US household will have at least one DVD player. Meanwhile, more than 70,000 DVD titles have been published for Region 1 (US and Canada) since 1997. The increasing number of published DVD titles and the proliferation of digital media jukeboxes and online services demand effective and efficient methods and apparatus for indexing and uniquely identifying a DVD disc.

A digital object can be uniquely identified. Here the term “digital object” is defined as a digital file or bitstream, or a composition of multiple digital files or bitstreams. For example, digital objects can include a computer file stored on a hard disc drive and video bitstreams broadcast or streamed to a TV or computer. A DVD or more precisely the content on a DVD can also be characterized as a digital object comprising multiple files stored on the DVD disc. The structure, format and organization of content on DVDs is described in “DVD Specifications for Read-Only Disc, Part 3: Video Specifications,” Version 1.1, December 1997, published by the DVD Forum. As is known in the art, a digital object can be uniquely identified by passing the object through a hash function that produces a fixed-length output known as hash sum or message digest. A hash sum of a digital object is often called a digital fingerprint because it can be used to uniquely identify the digital object. A popular hash function that is often used to generate digital fingerprint of a digital object is the RFC 1321 specified MD5 hash function. Hereinafter, the term “fingerprint” will be used interchangeably with the term “digital fingerprint.”

While it is useful to fingerprint a DVD by passing all of its data through a hash function such as the MD5 hash function, a fingerprint so generated is often inadequate for advanced identification tasks. For example, a pirated DVD will have a MD5 hash sum that is completely different from that of the original DVD, and the hash sum of the pirated DVD may appear to have no relationship to the hash sum of the original DVD. Similarly, a DVD containing a wide-screen version of a movie may not be easily related to a DVD containing the full-screen version of the same movie because their MD5 hash sums are different. Thus to be able to distinguish a pirated DVD from the original or one version of a movie from another, a more sophisticated method and apparatus for fingerprinting and identifying DVDs is required.

### BRIEF SUMMARY OF THE PARENT INVENTION

Certain embodiments of the invention provide systems and methods for associating a video object with digital fingerprints. The digital fingerprints can facilitate identification of the video object and operational characteristics of the video object based on matching calculated digital fingerprints with known fingerprints of known video objects. In certain embodiments, a match of some but not all of the calculated fingerprints may indicate that the video object is a copied or pirated version of an original video object.

Certain embodiments comprise systems and methods for obtaining fingerprints using a process that supports advanced identification capabilities. Fingerprints of a DVD can be obtained that allow the DVD to be uniquely identified and that may reveal certain aspects of the DVD. Certain data can be selectively added or removed from data extracted from the video object and used to calculate digital signatures such that absence or presence of the certain data embeds additional information into digital signatures. By generating multiple fingerprints having different embedded information, a plurality of characteristics and aspects of the DVD can be identified including origin of the DVD and operating characteristics of the DVD.

In certain embodiments, computation of a fingerprint comprises collecting of a string of bits and calculating a digital fingerprint from the string of bits where the fingerprint can be in the form of a hash sum, for example. In certain embodiments, playback devices or media players can access known signatures of known video objects maintained on one or more databases. The playback devices can receive a video object for playing and can identify the video object by calculating a plurality of digital fingerprints from the video object and comparing those objects to known signatures of known objects. Typically, the video object can be identifying by matching one or more signatures derived from video data encoded in the video object and can determine origin of the video object based on matching other digital signatures calculated from data extracted from the video object. The ability to determine information other than identity is akin to the ability to identify which finger or thumb cast a distinct fingerprint that can uniquely identify the person leaving the fingerprint.

### BRIEF DESCRIPTION OF THE DRAWINGS

FIG. 1 illustrates the construction of two strings of bits to be hashed or fingerprinted in a specific embodiment according to the present invention.

FIG. 2 illustrates the construction of another string of bits to be hashed or fingerprinted in a specific embodiment according to the present invention.

FIG. 3 is an abstracted diagram of an apparatus for DVD fingerprint matching and identification.

FIG. 4 is a flowchart of database queries that are part of the DVD identification process in a specific embodiment according to present invention.

FIG. 5 illustrates the optimized process of ingesting fingerprints from live signals and indexing the fingerprints in database.

FIG. 6 illustrates the waiting strategies applied when some of the live signal feeds are not ready for ingestion and query requests.

FIG. 7 illustrates the approach taken to dynamically adjust precision of fingerprints.

FIG. 8 illustrates the method and system to playback multi-angle videos synchronously.

### DETAILED DESCRIPTION OF THE PARENT INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention provide systems and methods for associating a video object with multiple fingerprints that facilitate identification of the video object. Certain embodiments comprise systems and methods for obtaining fingerprints using a process that supports advanced identification capabilities. In one example, fingerprints of a DVD can be obtained that allow the DVD to be uniquely identified and that may reveal certain aspects of the DVD. According to certain aspects of the invention, additional information can be embedded into certain of a plurality of fingerprints generated for the DVD such that each of the fingerprints is unique. Certain data can be selectively added or removed from data extracted from the video object and used to calculate digital signatures such that absence or presence of the certain data embeds additional information into digital signatures. By generating multiple fingerprints that embed different or additional information in signatures of a DVD a plurality of characteristics and aspects of the DVD can be identified. Certain embodiments of the present invention enable applications to uniquely identify a DVD disc upon insertion into a DVD drive, and determine the origins and/or provenance of the inserted DVD disc including determining whether the inserted DVD is an original, a copy of an original, or a pirated copy of an original and/or whether the DVD is an edition that contains a known feature or attribute.

### Fingerprinting Video Objects

In certain embodiments, computation of a fingerprint comprises collecting of a string of bits and calculating a digital fingerprint from the string of bits. In certain embodiments, the digital fingerprint is calculated by passing the string to a hash function to obtain the hash sum. Certain embodiments provide novel methods for constructing the strings of bits to be hashed or fingerprinted. In the example of a DVD discussed above, at least one constructed string can contain unaltered information that is directly extracted from the DVD disc. A base string (String-0) may be constructed from unaltered information extracted from a DVD, while a plurality of additional strings (String-N, where N=1, 2, 3 . . . ) may be constructed to contain altered information derived from the DVD disc. Thus, a string can be constructed from information extracted from a DVD to which certain bits may be added, removed or altered. Various alternate and complementary methods for constructing strings and generating fingerprints are contemplated to be within the scope of the present invention, although only a few examples will be presented for discussion herein.

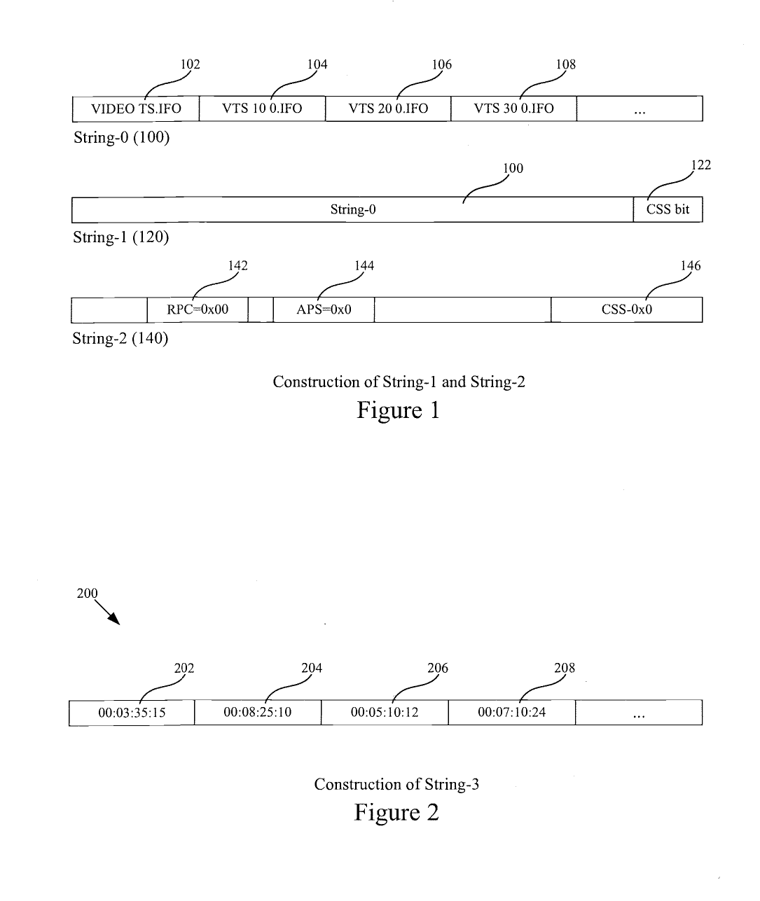

In one example, illustrated in FIGS. 1 and 2, a base string (String-0) 100 may be constructed by concatenating all information (“IFO”) files 102, 104, 106 and 108 that are found on a DVD disc. Next, String-1 120 can be constructed such that it contains String-0 100 followed by one or more bits 122 including bits that identify operational characteristics of the DVD such as bits indicating whether a DVD disc is encrypted using the Content Scrambling System (“CSS”). In certain embodiments, String-2 140 may be constructed using a masked version of String-1 120 and can include additional information and can mask certain information, including, for example, bits that identify the states of Region Protection Code (“RPC”) 142, CSS 146, and Analog Protection System (“APS”) 144. Masking typically causes masked bits to be cleared to zero or set to one.

More specifically, String-1 100 in the example includes the IFO files 102, 104, 106, 108 that can completely characterize the navigational structure of a DVD, and a CSS bit 120 that characterize the encryption state of the DVD. Therefore, a fingerprint generated from String-1 120 can uniquely identify the DVD. A fingerprint generated from String-2 140 can typically be identically generated from original, copied and pirated DVDs because the use of masked copies of RPC 142, CSS 146 and APS 144 typically renders the fingerprint invariant to modifications to RPC, CSS, and APS states that tend to be indicative of a pirated DVD disc.

In certain embodiments, fingerprints can be generated from information that identifies intrinsic characteristics of video objects. In one example, String-0 100, String-1 120, and String-2 140 can be constructed from a DVD as described above. In addition, a String-3 200 may be constructed by concatenating the playtime codes 202, 204, 206 and 208 of all chapters contained in the main feature title of the DVD. The playtime code 202, 204, 206 and 208 of a title or its chapter can be computed by parsing the IFO files of the DVD according to the DVD specifications. Since String-3 200 is constructed from the theatrical time structure of the content and are not directly representative of the bits stored on the DVD disc, the fingerprint that is generated from String-3 is typically invariant with respect to the screen format (aspect ratio) of the content (e.g., widescreen vs. full-screen), and other characteristics.

In another example, String-0 100, String-1 120, and String-2 140 can be constructed for a DVD as described in the previous examples. Additional strings can be constructed such that each additional string corresponds to a different title found in the DVD disc. More specifically, each additional string can be constructed by concatenating the playtime code of a unique title in the DVD disc.

The process of fingerprinting DVDs results in multiple fingerprints for each DVD. These fingerprints can be stored in a database or other repository along with information about the corresponding DVD. The fingerprints may be stored and/or maintained in a repository or database that is provided in local storage or on a network server. Since DVD are primarily used as a read-only disc (except during writing in DVD-RW, etc), all copies of the same DVD title will typically have one or more identical fingerprints.

### Identifying a DVD

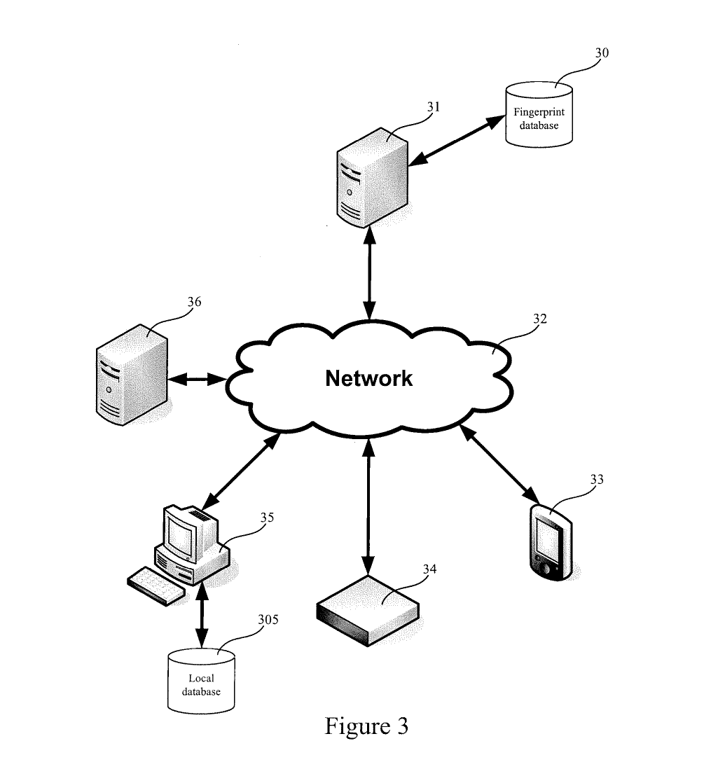

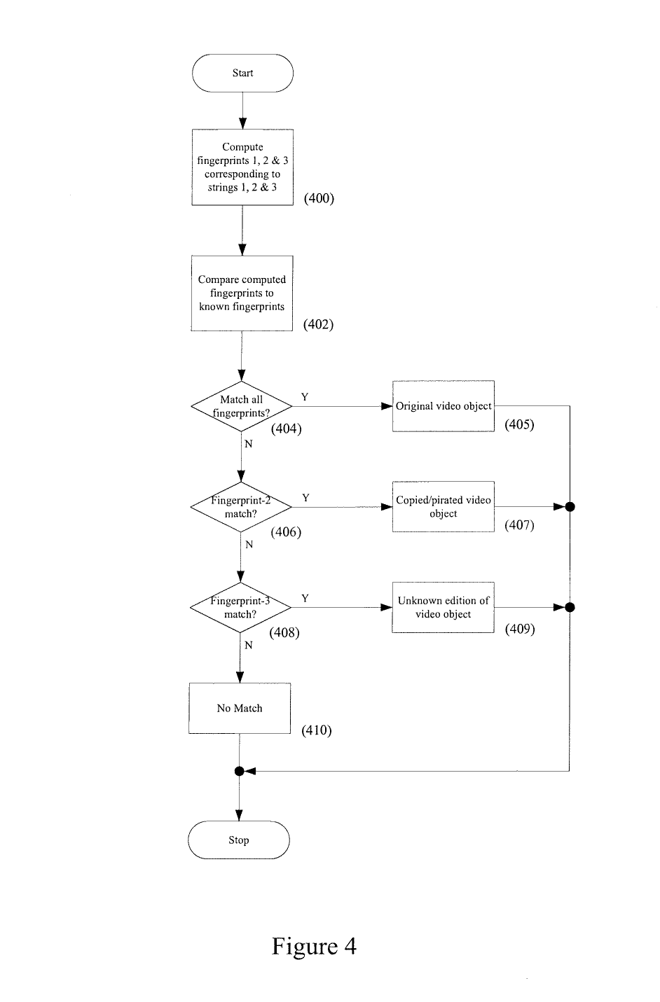

Certain embodiments provide systems and methods for identifying video objects, including DVD content by computing fingerprints for the video objects and comparing the computed fingerprints to a repository of known fingerprints for video objects. FIG. 3 provides a schematic representing a simplified example of a system according to certain aspects of the invention. In the example, playback devices 33, 34 and 35 can be any device equipped to play a video object including computers 35 such as PC and MAC systems, audio visual equipment such as DVD players and digital video recorders (“DVR”) 34 and mobile devices 33 adapted to provide video playback. Computing devices 35 may receive video objects from any available source, including integrated hard drives, DVD, HD-DVD and/or Blu-Ray players as well as streamed video objects received from a network 32.

In certain embodiments, playback devices access known signatures of video objects maintained on one or more databases 30. Some of databases 30 may be maintained by owners of video titles encoded in a video object. Some of databases may be maintained by organizations or groups associated with video titles, manufacturers and providers of video objects and other groups that may wish to provide services associated with video objects.

In one example, a database 30 can contain the known fingerprints of a plurality of DVDs. The database 30 may be accessed using database or other server 31. The fingerprints may be captured at point of manufacture of the DVDs using dedicated fingerprinting computers and servers 36 or may be acquired from information extracted by playback devices 33, 34 and 35.

Referring now also to FIG. 3, a process for identifying a video object is provided. For clarity of discussion purposes, an example of identifying a DVD will be referenced, where the video object for identification is DVD content and identification is sought by one of playback devices 33, 34 or 35. According to certain aspects of the present invention, a DVD identification process commences at step 400 by computing selected fingerprints of the DVD. Typically, fingerprints such as those described in relation to FIGS. 1 and 2 can be calculated by the playback device 33, 34 or 35 together with any other fingerprints that may be used to identify the content, structure and origin of the DVD.

At step 402 the fingerprints computed by the playback device 33, 34 or 35 may be compared to fingerprints identified with known video objects. Comparison can include interrogation of a network database 30. In some embodiments, local storage may be interrogated by playback device 33, 34 or 35 during matching of computed and known fingerprints. The local storage may include a cache of recently matched or frequently matched fingerprints. In some embodiments, a local database 305 may be supported by, for example, playback device 35 to maintain copies of known fingerprints and to assist rapid identification of video objects. In one example, a local DVD database (not shown) could be provided with a DVD player 34 where the local DVD database maintains fingerprints associated with commercially available DVDs. In another example, a DVR may be provided with a database identifying streamed video objects.

If it is determined at step 404 that all of the computed fingerprints match corresponding fingerprints of a known DVD, then the DVD in the playback device 33, 34 or 35 can be identified at step 405 as an original copy of the DVD. In certain embodiments, if less than all fingerprints are determined to be matched at step 404, then other determination of DVD origin may be made. At step 406, for example, if computed and known versions of Fingerprint-2 (see FIG. 1) are matched, then it may be determined at step 407 that a non-original or pirated copy of the DVD has been inserted into the playback device 33, 34 or 35. Similarly, if at step 408, computed and known versions of Fingerprint-3 (see FIG. 1) are matched, then it may be determined at step 409 that a non-original copy of the DVD has been inserted into the playback device 33, 34 or 35 but the copy represents an edition that has not yet been identified to the fingerprint repository. If no fingerprints can be matched, then at step 410, the DVD may be determined to be an original work, an altered version of a known video object.

### Additional Descriptions of Certain Aspects of the Original Invention

Certain embodiments of the invention provide a method of fingerprinting a video object comprising extracting data from the video object, calculating one or more digital fingerprints of the extracted data, and maintaining a copy of the one or more digital fingerprints in association with information identifying the video object, wherein the extracted data includes encoded video, and wherein at least one of the digital fingerprints uniquely identifies a portion of the encoded video. In certain of these embodiments, the video object includes a DVD comprising a plurality of information files. In certain of these embodiments, the one or more digital fingerprints include a first digital fingerprint calculated from the plurality of information files. In certain of these embodiments, the one or more digital fingerprints include a second digital fingerprint calculated from the plurality of information files and additional information identifying operational characteristics of the DVD. In certain of these embodiments, the additional information includes a code identified with Content Scrambling System. In certain of these embodiments, the additional information includes a Regional Protection Code. In certain of these embodiments, the additional information includes Analog Protection System bits. In certain of these embodiments, the identified operational characteristics identify origin of the DVD. In certain of these embodiments, the one or more digital fingerprints identify content, structure and origin of a DVD. Certain of these embodiments also comprise a step of providing the one or more digital fingerprints and information identifying the DVD to a repository of digital fingerprints. In certain of these embodiments, the one or more digital fingerprints identify content and origin of the video object and further comprising providing the one or more digital fingerprints and information identifying the video object to a repository of digital fingerprints.

Certain embodiments comprise a computer readable medium encoded with data and instructions for fingerprinting a video object, the data and instructions causing an apparatus executing the instructions to extract data from the video object, calculate one or more digital fingerprints of the extracted data, and store a copy of the one or more digital fingerprints and information identifying the video object, wherein the extracted data includes encoded video, and wherein at least one of the digital fingerprints uniquely identifies a portion of the encoded video. In certain of these embodiments, the video object includes a DVD comprising a plurality of information files. In certain of these embodiments, the one or more digital fingerprints include a first digital fingerprint calculated from the plurality of information files. In certain of these embodiments, the one or more digital fingerprints include a second digital fingerprint calculated from the plurality of information files and additional information identifying operational characteristics of the DVD. In certain of these embodiments, the additional information includes a code identified with Content Scrambling System. In certain of these embodiments, the additional information includes a Regional Protection Code. In certain of these embodiments, the additional information includes Analog Protection System bits. In certain of these embodiments, the identified operational characteristics identify origin of the DVD. In certain of these embodiments, the one or more digital fingerprints identify content, structure and origin of a DVD. Certain of these embodiments include data and instructions causing an apparatus to provide the one or more digital fingerprints and information identifying the DVD to a repository of digital fingerprints. In certain of these embodiments, the one or more digital fingerprints identify content and origin of the video object. Certain of these embodiments include data and instructions causing an apparatus to provide the one or more digital fingerprints and information identifying the video object to a repository of digital fingerprints.

Certain methods provide a method of identifying a video object comprising extracting data including encoded video from the video object, calculating one or more digital fingerprints based on the extracted data, and matching at least one of the one or more calculated digital fingerprints with corresponding known digital fingerprints of a known video object, wherein a calculated digital fingerprint uniquely identifies a portion of the encoded video. Certain of these embodiments also comprise identifying the video object based on information associated with the corresponding known digital fingerprints. In certain of these embodiments, the video object is identified by matching the calculated digital fingerprint with a corresponding known digital fingerprint of the known video object. In certain of these embodiments, the video object comprises a DVD including a plurality of information files. In certain of these embodiments, the digital fingerprint is calculated from the plurality of information files. In certain of these embodiments, the one or more digital fingerprints include digital fingerprints calculated from the plurality of information files and additional information corresponding to the DVD. In certain of these embodiments, the additional information includes a code identified with a Content Scrambling System. In certain of these embodiments, the additional information includes a Regional Protection Code. In certain of these embodiments, the additional information includes Analog Protection System bits. In certain of these embodiments, the matching includes determining the provenance of the DVD, wherein the DVD is determined to be an original DVD when all of the one or more digital fingerprints are identical to corresponding digital fingerprints of a previously fingerprinted DVD. In certain of these embodiments, a match of fewer than all of the one or more digital fingerprints are identical to corresponding digital fingerprints of the previously fingerprinted DVD is indicative of a copied DVD.

Certain embodiments comprise a computer readable medium encoded with data and instructions for identifying a video object that cause an apparatus to extract data including encoded video from the video object, calculate a plurality of digital fingerprints of the extracted data, and match at least one of the calculated digital fingerprints with corresponding known digital fingerprints of a known video object, wherein one or more of the calculated digital fingerprints uniquely identifies a portion of the encoded video. Certain of these embodiments include data and instructions that can cause an apparatus to identify the video object based on information associated with the corresponding known digital fingerprints. In certain of these embodiments, the video object comprises a DVD including a plurality of information files. In certain of these embodiments, the one or more digital fingerprint is calculated from the plurality of information files. In certain of these embodiments, the one or more digital fingerprints include other digital fingerprints calculated from the plurality of information files and operational information corresponding to the DVD. In certain of these embodiments, the operational information includes a code identified with a Content Scrambling System, a Regional Protection Code and Analog Protection System bits. Certain of these embodiments include data and instructions that can cause an apparatus to determine the origins of the DVD, wherein the DVD is determined to be an original DVD when certain of the one or more digital fingerprints are identical to corresponding digital fingerprints of a previously fingerprinted DVD. In certain of these embodiments, the known digital fingerprints are maintained in a digital fingerprint repository. In certain of these embodiments, the digital fingerprint repository is maintained in a database. In certain of these embodiments, the apparatus is a DVD player. In certain of these embodiments, the apparatus is a computer. In certain of these embodiments, the apparatus is a digital video recorder.

Certain embodiments provide a system for identifying a video object comprising a media player adapted to extract data including encoded video from the video object, and a processor configured to calculate one or more digital fingerprints from the extracted data, and match at least one of the one or more calculated digital fingerprints with corresponding known digital fingerprints of a known video object, wherein at least one calculated digital fingerprint uniquely identifies a portion of the encoded video. In certain of these embodiments, the known digital fingerprints are maintained in a digital fingerprint repository. In certain of these embodiments, the digital fingerprint repository is maintained in a database locally accessible by the processor. In certain of these embodiments, the digital fingerprint repository is maintained in a database accessible by the processor through a network. In certain of these embodiments, the media player is a DVD player. In certain of these embodiments, the media player is a provided in a computer. In certain of these embodiments, the media player is a digital video recorder. In certain of these embodiments, the video object comprises a DVD including a plurality of information files and the one or more digital fingerprints include digital fingerprints calculated from the plurality of information files and operational information corresponding to the DVD.

Certain embodiments provide system for fingerprinting a video object comprising a processor configured to calculate digital fingerprints of data extracted from the video object, and storage accessible to the processor for storing the digital fingerprints in association with information related to the video object, wherein the extracted data includes encoded video, and wherein at least one of the digital fingerprints uniquely identifies a portion of the encoded video with the video object.

In certain of these embodiments, the video object is a DVD comprising a plurality of information files. In certain of these embodiments, the digital fingerprints include a first digital fingerprint calculated from the plurality of information files. In certain of these embodiments, the digital fingerprints include a second digital fingerprint calculated from the plurality of information files and additional information identifying operational characteristics of the DVD. In certain of these embodiments, the additional information includes a code identified with Content Scrambling System. In certain of these embodiments, the additional information includes a Regional Protection Code. In certain of these embodiments, the additional information includes Analog Protection System bits. In certain of these embodiments, the identified operational characteristics identify origin of the DVD. In certain of these embodiments, the digital fingerprints identify content, structure and origin of a DVD.

### IMPROVEMENTS IN THE PARENT APPLICATION

The parent application was to extend the DVD to other content mediums including media files and network streams, etc, and extend the video objects to media contents including videos, images and audios.

For comparison, the original and initial application covers the following key disclosures:
a) Extracting only one fingerprint for each DVD or one media content.
b) The matching result of fingerprint is only for the identification of original, copy or illegal copy of media contents.
c) The media player only has one fingerprint extraction and match operation before processing said video content (to be played), in order to decide whether said video content is permitted to be played.

The parent invention continued on from the original application and extended to disclose:
a) Processing media contents including video or audio contents based on different segments, and extracting multiple fingerprints based on said segments with timestamps of five-second interval, for example, or processing media contents including video or audio contents based on different framerates, and extracting multiple fingerprints based on said framerates, wherein said segments are selected based on complexity of said media contents, and said framerates are determined based on resolution of said media contents.
b) Providing more accurate fingerprint matching results and further processes based on timing of timestamps, including displaying detailed information or advertisement at specific time, replaying or skipping specific segments, masking partial videos or audios, etc.
c) The media player including mobile device is continuously executing fingerprint extraction and match operation before and during playing media contents, and is able to real-timely conduct necessary processes based on match results.
d) Extending the content mediums from physical medium including DVD to virtual medium including blue-ray, file, stream, different AV (audio video) encoded medium, etc.
e) Extending the DVD detection of original content or copy of content to the next level of source detection of detecting the content itself for video or audio programs.
f) Said complexity can be determined by calculating the changes of contents within certain time window or the content elements within certain display window, and said resolution can be calculated based on how many frames within certain time windows.
g) Said complexity means that, within certain time window, more digital fingerprints will be extracted if said media contents change too much, which also means that, when the number of said digital fingerprints is fixed for each said segment, the length of each said segment is shorter if said media contents change faster.

Furthermore, in the original application, the entire DVD or its complete video object are the main targets to be processed. The original identification method is to ingest then match the entire DVD video content. Based on this method, we extended it to such a way that the DVD content is disassembled to clips or even image frames, which are then ingested and matched continuously. The method comprises:
a) Disassemble the video object to image frame sequence and audio waveform, and keep record of the corresponding timestamps.
b) Ingest characteristics from image frames and audio waveforms, and integrate the generated characteristics with corresponding timestamps. Due to insignificant differences between adjacent frames, we can pre-process those frames to avoid unnecessary ingestion, and to optimize performance.
c) Store the ingested characteristics together with corresponding timestamps into database.
d) Mark related application data information on timeline according to corresponding image or audio characteristics. Related application data information can be detailed introduction, advertisements and promotions, or play license, etc.
e) Video player (both physical and virtual player) can use the same algorithms to ingest continuous characteristics from decoded images and audio during playback. In order to reduce computing resources for ingestion, we can pre-process the object to be ingested, to avoid unnecessary ingestion, and to optimize performance.
f) Video player sends the ingested characteristics to database for identification. Video player performs characteristics ingestion and sends characteristics to database irregularly based on external conditions, such as when user pauses or switches the video, etc.
g) Upon successful identification, database returns timestamp of the matched content, as well as the previously marked application data information. Application data information can be continuously returned with corresponding timestamps. Database can also send multiple application data information related to the matched timestamp. Application data information will be changed when database receives new characteristics and yields new matches.
h) Video player performs requested operations based on application data information. The requested operations can display detailed information, show advertisements, skip certain clips, or mute certain segments of the audio, etc.
i) Said characteristics may contain key words of the contents, key clips of the contents, selected segments of the contents, critical parts of the contents or compressed version of the contents, defined and configured by owners or authorized users of the media contents.

In summary, the parent invention comprised:

A method of fingerprinting media contents comprising:
a) extracting data from said media contents, said extracted data including encoded videos or audios, segments of videos or audios, image frames, audio waveforms and associated timestamps;
b) generating a plurality of digital fingerprints from said extracted data of said media contents;
c) processing said media contents including video or audio contents based on different segments, and extracting multiple fingerprints based on said segments with timestamps, or processing said media contents including video or audio contents based on different framerates, and extracting multiple fingerprints based on said framerates, wherein said segments are selected based on complexity of said media contents, and said framerates are determined based on resolution of said media contents;
d) continuously executing fingerprint extraction and match operation before and during playing said media contents, and being able to real-timely conduct necessary processes based on match results;
e) providing more accurate fingerprint matching results and further processes, based on timing of timestamps, including displaying detailed information or advertisement at specific time; replaying, muting or skipping specific segments; masking partial videos or audios, and
f) maintaining, in a database, a copy of said plurality of digital fingerprints in association with information identifying said media contents.

The aforementioned plurality of digital fingerprints identify content and origin of said media contents and further comprising providing said plurality of digital fingerprints and information identifying said media contents to a repository of digital fingerprints.

The aforementioned media contents are in content mediums from physical medium including DVD (Digital Versatile Disc) to virtual medium including media file, network stream, different AV (audio video) encoded medium.

The aforementioned digital fingerprints can be in the form of single-file fingerprint or multiple pieces of same fingerprint with timestamping in each piece in order to be transmitted over different networks with different connection speeds.

Each said media content may have multiple said fingerprints for said different segments or content parts of said different framerates.

The aforementioned fingerprint extraction improves existing fingerprint generation for video objects comprising disassembling said video object to image frame sequence and audio waveform and keeping record of corresponding timestamps, and ingesting characteristics from image frames and audio waveforms and integrating generated characteristics with said corresponding timestamps.

The aforementioned complexity can be determined by calculating the changes of contents within certain time window, and said resolution can be calculated based on how many frames within certain time windows.

The aforementioned complexity means that, within certain time window, more digital fingerprints will be extracted if said media contents change too much, which also means that, when the number of said digital fingerprints is fixed for each said segment, the length of each said segment is shorter if said media contents change faster.

The method of said fingerprint extraction is privately defined between mobile cloud clients and mobile cloud servers wherein said mobile cloud clients include smartphones, tablets, mobile media players or mobile computers, and said mobile cloud servers include identification server, fingerprints database server or computer server.

The aforementioned plurality of digital fingerprints enable said media contents to be replayed, muted, skipped or replaced with advertisements in any specific timing point when playing said media contents.

A method of identifying media contents comprising:
a) extracting data from said media contents, said extracted data including encoded videos or audios, segments of videos or audios, image frames, audio waveforms and associated timestamps;
b) generating a plurality of digital fingerprints from said extracted data of said media contents;
c) processing said media contents including video or audio contents based on different segments, and extracting multiple fingerprints based on said segments with timestamps, or processing said media contents including video or audio contents based on different framerates, and extracting multiple fingerprints based on said framerates, wherein said segments are selected based on complexity of said media contents, and said framerates are determined based on resolution of said media contents;
d) continuously executing fingerprint extraction and match operation before and during playing said media contents, and being able to real-timely conduct necessary processes based on match results;
e) providing more accurate fingerprint matching results and necessary processes, based on timing of timestamps, including displaying detailed information or advertisement at specific time; replaying, muting or skipping specific segments; masking partial videos or audios;
f) identifying said media contents by matching at least one of the calculated said digital fingerprints with corresponding said digital fingerprints of known media contents, supporting said different segments and said different framerates; and
g) determining whether said media contents are copies of said known media contents as well as conducting said necessary processes based on match results.

The aforementioned identifying media contents is performed in mobile devices, media players, mobile computers or in identification servers.

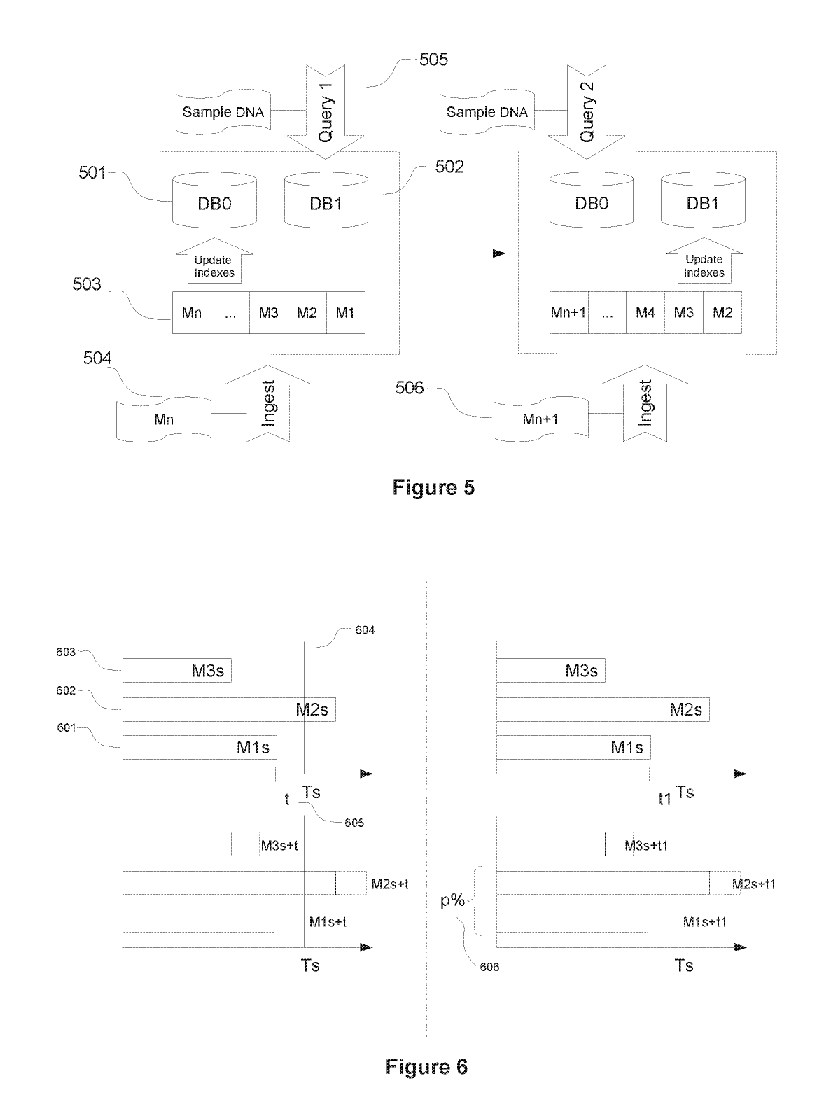

Improvements in the Present Continuation Application in FIG. 5 through FIG. 8

The present continuation application is to extend the systems and methods of fingerprinting and identifying pre-recorded video and audio media content to live broadcasting signals.

For comparison, the parent application covers the following key disclosures:
a) On the server side, extracting and ingesting plurality of fingerprints for encoded audio, video and image media contents which are presumably pre-recorded in content mediums such as DVDs, media files and network streams, etc. [0060]
b) The matching results from identifying fingerprints are used for further processes on the same media content whose characteristics are sent for identification. [0042]
c) Accurate offset information in the matching results is only for displaying time related information, which can be utilized for more purposes such as synchronising playback of multiple videos.
d) The video player is only for playback of one media content per time and continuously extract fingerprints from said media content. [0053]

The present continuation invention continues on from the parent application and extends to disclose:

The identification server is able to process media contents including video and audio which may broadcast from live events, and extract fingerprints based on said real-time broadcasting signals. Said extracted fingerprints can be stored in one or more fingerprint database servers continuously as the live broadcasting feeds are being processed.

Pre-recorded media contents are often processed within sufficient time, which may be completely fingerprinted and ingested before matching requests are sent from client side (e.g. media players running on terminals such as PC, mobile devices, etc, which continuously executing fingerprint extraction and match operation during playing media contents). On the other hand, due to the realtime nature of live broadcasting signals, the time window between fingerprint extraction/ingestion on the server side and matching requests from the client side may be narrowed down to a magnitude of seconds. In rare conditions, such as signal receiver latency, the time when a server receives matching request from a client may even precede the extraction time of corresponding content from a live signal.

Moreover, ingesting fingerprints from real-time live signals has a specific difficulty to overcome which does not occur in pre-recorded fingerprint ingestion. Unlike processing pre-recorded video fingerprints which can be ingested and indexed in fingerprint database before actual match requests, image frames from live signals need to be captured, fingerprinted and indexed in database continuously within at most 1 second interval. Under the constraint of algorithm complexity and calculation capacity, the routine of having a frame of image fingerprinted and indexed in a database may take a certain amount of time (depending on the capacity of the database, in the case of a light database for live signals usually it may take hundreds of milliseconds), during this period the database may be halted, query requests may be queued until the fingerprint ingestion is done and indexed. Considering such halt for query requests may occur repeatedly, the following steps may be taken to ensure the availability of query service, as illustrated in FIG. 5.

Maintaining small capacity active databases 501 and 502 storing limited amount of fingerprints 503, so that indexing the whole database wouldn't take too long. Said set of limited amount of fingerprints can be collected within a duration such as up to 30 to 60 seconds, the whole process of ingesting and indexing new fingerprints should not exceed a certain threshold of time period, say hundreds of milliseconds.

Apply databases rotation strategy. As depicted in FIG. 5, a new fingerprint 504 has been ingested from the most recent frame of the live signal, it will be added to the limited set of fingerprints 503, and then it will be stored and indexed in database 501. At the time of index be updated in 501, it will be halted for query requests, all query requests will be routed to database 502 so as to guarantee availability of service. At the next moment, when processing a newer fingerprint 506, database 501 will be ready for query with former fingerprint 504 indexed, therefore database 502 will take turn for fingerprint ingesting and indexing, while database 501 accepts query requests.

Both active small capacity databases 501 and 502 maintains a set of limited amount of fingerprints. When latest fingerprint is added to an active database, if total number of existing fingerprints exceeds said limited amount, the oldest fingerprint in the set will be removed.

The active databases described above only maintains said limited duration of fingerprints, in some scenarios it may require that contents captured before said limited duration could be able to query as well. To fulfill said requirement, the server can also implement a large capacity database beside the small capacity active databases used for rotation, and periodically merge fingerprints and indexes from said active databases to said large capacity database. When query request hits neither of the active databases, it can attempt the large capacity database which maintains fingerprints that dated earlier.

Since fingerprint extraction on live signals is realtime and continuous, upon receiving matching requests from the clients, identification server checks the timestamp along with the matching request against last updated timestamps of all realtime fingerprinting live broadcast signals. Under the rare circumstances where the fingerprinting extraction on any of the live signal feeds are behind the timestamp from the matching request due to probably delay or temporary failure, the identification server may apply waiting strategies on the execution of the matching request.

For instance, 601, 602 and 603 are 3 live signal feeds to be ingested, where feed 602 is in normal status, but feeds 601 and 603 are slightly behind due to signal latency. A query request is received at timestamp 604, however only contents from live feed 602 is available for query at this moment because both delayed feeds do not have latest content ingested and probably could not match the query request. A specific timeout 605 can be set or calculated according to the interval between query request timestamp 604 and all or some of the delayed feeds, so that the query request will be hold for a duration of the said timeout. After the period defined by timeout 605, most of the live feeds should be ready for query, and the query request can be executed with more probability of an accurate result. Those feeds couldn't meet the deadline of the said timeout, feed 603 in this case, may be problematic and may be dropped and server administrators may get notified.

Instead of setting a said timeout, another approach may be applied by defining an accepted percentage of valid live feeds. The percentage threshold 606 is defined so that the server may hold the query requests until said percentage of live feeds are ready for query, and then execute the query request. According to the percentage threshold defined in 606, when both contents from feeds 601 and 602 are ingested and indexed, the query request can be executed with more probability of an accurate result. Those feeds fall out of the defined threshold, feed 603 in this case, may be problematic and may be dropped and server administrators may get notified.

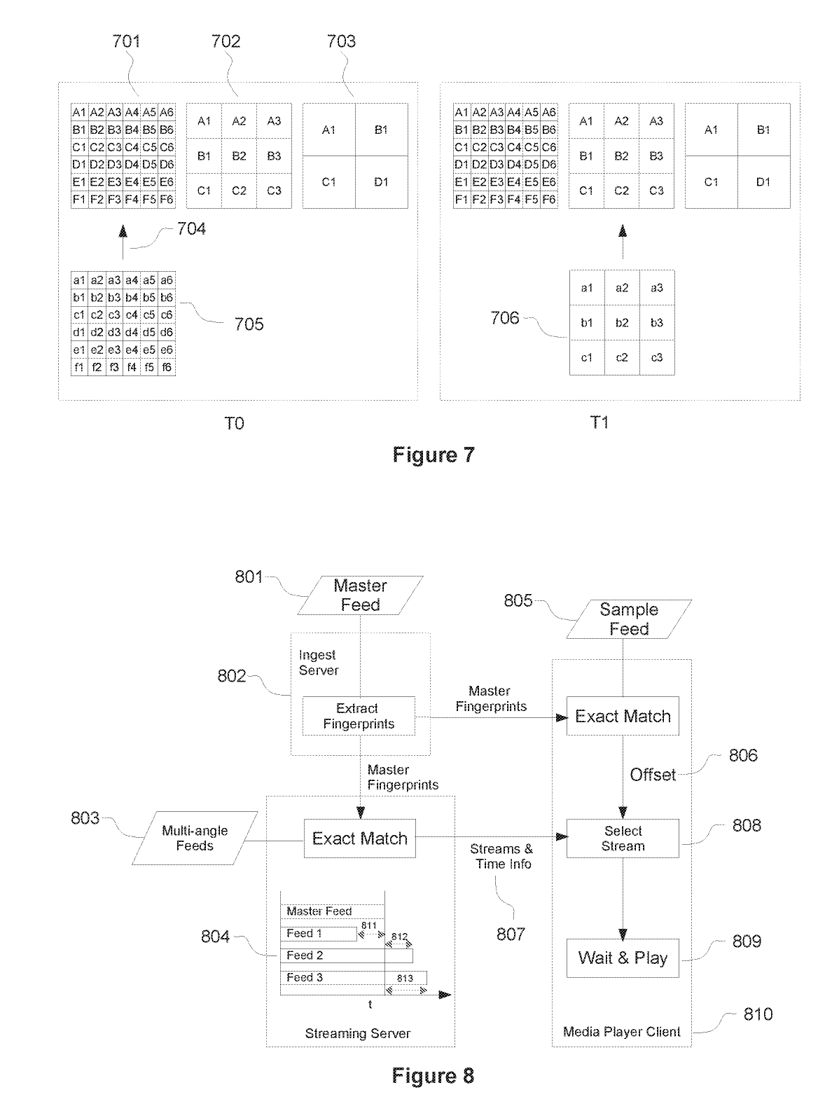

The above said strategies may be combined and applied in actual implementations. In the situation that computing resources or network bandwidth become bottleneck on terminals such as mobile devices which attempt to identify the video or audio contents playing on them, they may try to execute dynamically adjusted fingerprint extraction and send multiple query requests for identification, as depicted in FIG. 7.

701, 702 and 703 represents a set of fingerprints with different preset precisions ingested from a single moment of live signal media content on server side, while 705 represents a normal fingerprint extracted from media content from client side which may be sent within a query request. 704 is the action executed to identify the query request, since 705 is extracted in normal precision, it is matched against fingerprint 701 with similar precision.

Due to computing resources or network bandwidth constraints, the media player clients such as mobile devices may encounter difficulties when performing or sending full precision fingerprint extraction may require more time or resources than needed. Under such circumstances, the media player client may decide to dynamically lower the precision for fingerprint extraction, as depicted in 706. The dynamically adjusted extraction of fingerprints costs much less resources and time to execute and more compact to be transmitted under less optimised network conditions. The selection of precision to extract fingerprints is calculated based on the running condition of various parameters on the media player clients, such as CPU consumption, memory usage, network bandwidth, etc. The trade-off of this strategy is that the server may require more requests with lower precision fingerprints from the client to aggregate an accurate match result, therefore the identification process may take longer.

When the state of the media player client resumes normal, fingerprint extraction may be dynamically adjusted with normal parameters.

Extending the media player from playback of only one media content per time to a set of media players on the same device or different devices which can be able to play multi-angle videos synchronously. Said multi-angle videos are required to be simultaneously playback on several media players, often but not limited to displaying recordings of the same event from multiple angles of cameras. One common character of said multi-angle videos is that they share the same source and timeline of audio content, while video contents can be either completely different, similar or identical. Said multi-angle videos can be of various content mediums including media files and network streams, etc. By identifying the audio track from one or more of the media players which are playing said multi-angle videos, using the timestamp offset (with frame precision) from accurate identification result, all media players playing said multi-angle videos can adjust and synchronize their own playback timeline such that this set of multi-angle videos are able to playback simultaneously.

The system should include as input a master feed 801 which is usually the live signal that will be broadcasting, a sample feed 805 which is identical to said master feed and is usually the live signal that is broadcasting on first screens such as TV, and several multi-angle feeds which may stream over Internet and playable on media player clients 810 as second screens, also it should include an ingest server 802, and a streaming server 804.

The live signal master feed 801 is continuously processed in ingest server 802, the fingerprints extracted contains accurate offset information from said master feed, and are respectively distributed to streaming server and all registered media player clients 810.

The multi-angle feeds provided by content owner may be not accurately aligned in time due to various reasons, for instance signal delay, processing latency, etc, as depicted in 804. Therefore the streaming server needs to calculate the time difference precisely to frame between each multi-angle feeds and the said master feed. By executing exact match between the fingerprints extracted from said ingest server 802 and those extracted lively from each multi-angle feeds, the precise time difference between said master feed and each one of the multi-angle feeds can be achieved, respectively 811, 812 and 813. The stream server can then relay the multi-angle streams over Internet to media player clients along with said precise time information of each feeds.

The media player client 810 continuously receives said master fingerprints of said master feed from ingest server, and performs exact match against the sample feed 805 from the first screen, usually live signal broadcasting on TV, so that the offset 806 of said sample feed can be acquired with precision to frame.

The media player client then can select one or more streams from said streaming server to playback. Based on the timeline of the selected stream, said offset 806 of said sample feed, and precise time difference 807 calculated between selected multi-angle stream and said master feed, an accurate point of time on the timeline of said selected multi-angle stream can be calculated so that the playback of said selected multi-angle stream can be accurately synchronized with said sample feed. Since most live streaming protocols do not support seek operation, it may require that the timeline of said streaming multi-angle contents for the media players should be ahead of said sample feed, and the media players should be able to buffer the streaming contents, so that the media player client can calculate the interval between expected play time and current play time of said selected multi-angle stream, and pause the buffered stream until the duration defined by said interval elapses, so as to keep the playback of said selected multi-angle stream in sync with said sample feed.

In summary, the present invention discloses the following:

A method of fingerprinting and identifying real-time broadcasting signals, said method comprising:
a) optimized process of ingesting fingerprints from live signals and indexing said fingerprints in database,
b) waiting strategies applied when some of said live signal feeds not ready for ingestion and query requests,
c) executing dynamically adjusted fingerprint extraction by server and client when computing resources or network bandwidth becoming bottleneck on media player terminals such as mobile devices, and
d) synchronous playback of multi-angle videos on media players using accurate fingerprint match offsets through master broadcast feed and multi-angle video feeds.

The aforementioned optimized process includes maintaining small capacity databases and applying rotation strategy on said small capacity databases.

The aforementioned small capacity databases maintain only limited duration of fingerprints, and are updated frequently.

The aforementioned optimized process also includes periodically merged fingerprints and indexes from said small capacity databases to a large capacity database for the requirement of being able to query broader range of contents.

The aforementioned server maintains a set of fingerprints with different preset precisions ingested from a single moment of live signal content.

The aforementioned client decides to extract and send normal or lower precision fingerprints based on various parameters such as CPU (central processing unit) consumption, memory usage and network bandwidth on media player clients.

The aforementioned master broadcast feed is processed in an ingest server, and its fingerprints are continuously sent to a streaming server and said media players.

The aforementioned multi-angle video feeds are processed in said streaming server, performing exact match against said fingerprints of said master broadcast feed to calculate precise time difference between each said multi-angle video feeds and said master broadcast feed.

The aforementioned media players use said time difference on each said multi-angle video feeds and the offset from exact match against said master broadcast feed and sample feed, to compute the accurate point of play time of each said multi-angle video feeds.

By pausing the buffered multi-angle streams by said multi-angle video feeds until said accurate point of play time, each of said multi-angle streams can be played back synchronously along with said sample feed.

A system of fingerprinting and identifying real-time broadcasting signals, said system comprising:
a) subsystem for optimized process of ingesting fingerprints from live signals and indexing said fingerprints in database,
b) subsystem for waiting strategies applied when some of said live signal feeds not ready for ingestion and query requests,
c) subsystem for executing dynamically adjusted fingerprint extraction by server and client when computing resources or network bandwidth becoming bottleneck on media player terminals such as mobile devices, and
d) subsystem for synchronous playback of multi-angle videos on media players using accurate fingerprint match offsets.

The aforementioned synchronous playback requires system units comprised of an ingesting server, a streaming server and several media players.

Input sources of said system units include a master broadcasting feed, several multi-angle feeds and a sample feed.

The aforementioned master broadcasting feed is usually the live signal that will be broadcasting, and said sample feed is identical to said master broadcasting feed and is usually the live signal that is broadcasting on first screens such as TVs.

The aforementioned multi-angle feeds may stream over Internet and are playable on media player clients such as second screens.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed:

1. A method of fingerprinting and identifying real-time broadcasting signals, said method comprising:
a) optimized process of ingesting fingerprints from live signals and indexing said fingerprints in database,
b) waiting strategies applied when some of said live signal feeds not ready for ingestion and query requests,
c) executing dynamically adjusted fingerprint extraction by server and client when computing resources or network bandwidth becoming bottleneck on media player terminals such as mobile devices, and
d) synchronous playback of multi-angle videos on media players using accurate fingerprint match offsets through master broadcast feed and multi-angle video feeds.

2. The method as recited in claim 1, wherein said optimized process includes maintaining small capacity databases and applying rotation strategy on said small capacity databases.

3. The method as recited in claim 2, wherein said small capacity databases maintain only limited duration of fingerprints, and are updated frequently.

4. The method as recited in claim 1, wherein said optimized process also includes periodically merged fingerprints and indexes from said small capacity databases to a large capacity database for the requirement of being able to query broader range of contents.

5. The method as recited in claim 1, wherein said server maintains a set of fingerprints with different preset precisions ingested from a single moment of live signal content.

6. The method as recited in claim 1, wherein said client decides to extract and send normal or lower precision fingerprints based on various parameters such as CPU (central processing unit) consumption, memory usage and network bandwidth on media player clients.

7. The method as recited in claim 1, wherein said master broadcast feed is processed in an ingest server, and its fingerprints are continuously sent to a streaming server and said media players.

8. The method as recited in claim 1, wherein said multi-angle video feeds are processed in said streaming server, performing exact match against said fingerprints of said master broadcast feed to calculate precise time difference between each said multi-angle video feeds and said master broadcast feed.

9. The method as recited in claim 1, wherein said media players use said time difference on each said multi-angle video feeds and the offset from exact match against said master broadcast feed and sample feed, to compute the accurate point of play time of each said multi-angle video feeds.

10. The method as recited in claim 9, wherein by pausing the buffered multi-angle streams by said multi-angle video feeds until said accurate point of play time, each of said multi-angle streams can be played back synchronously along with said sample feed.

11. A system of fingerprinting and identifying real-time broadcasting signals, said system comprising:
a) subsystem for optimized process of ingesting fingerprints from live signals and indexing said fingerprints in database,
b) subsystem for waiting strategies applied when some of said live signal feeds not ready for ingestion and query requests,
c) subsystem for executing dynamically adjusted fingerprint extraction by server and client when computing resources or network bandwidth becoming bottleneck on media player terminals such as mobile devices, and
d) subsystem for synchronous playback of multi-angle videos on media players using accurate fingerprint match offsets.

12. The system as recited in claim 11, wherein said optimized process includes maintaining small capacity databases and applying rotation strategy on said small capacity databases.

13. The system as recited in claim 12, wherein said small capacity databases maintain only limited duration of fingerprints, and are updated frequently.

14. The system as recited in claim 11, wherein said optimized process also includes periodically merged fingerprints and indexes from said small capacity databases to a large capacity database for the requirement of being able to query broader range of contents.

15. The system as recited in claim 11, wherein said server maintains a set of fingerprints with different preset precisions ingested from a single moment of live signal content.

16. The system as recited in claim 11, wherein said client decides to extract and send normal or lower precision fingerprints based on various parameters such as CPU (central processing unit) consumption, memory usage and network bandwidth on media player clients.

17. The system as recited in claim 11, wherein said synchronous playback requires system units comprised of an ingesting server, a streaming server and several media players.

18. The system as recited in claim 17, wherein input sources of said system units include a master broadcasting feed, several multi-angle feeds and a sample feed.

19. The system as recited in claim 18, wherein said master broadcasting feed is usually the live signal that will be broadcasting, and said sample feed is identical to said master broadcasting feed and is usually the live signal that is broadcasting on first screens such as TVs.

20. The system as recited in claim 18, wherein said multi-angle feeds may stream over Internet and are playable on media player clients such as second screens.
